(19) United States
(12) Patent Application Publication
(10) Pub. No.: US 2020/0055733 A1
(43) Pub. Date: Feb. 20, 2020

(54) CARBON NANOTUBE, CARBON-BASED FINE STRUCTURE, AND SUBSTRATE HAVING CARBON NANOTUBE, AND METHOD RESPECTIVELY FOR PRODUCING THESE PRODUCTS

(71) Applicant: TAIYO NIPPON SANSO CORPORATION, Tokyo (JP)

(72) Inventors: Katsunori TAKADA, Kai-shi (JP); Toru SAKAI, Yokohama-shi (JP)

(21) Appl. No.: 16/486,568

(22) PCT Filed: Mar. 1, 2018
(86) PCT No.: PCT/JP2018/007762

§ 371 Date: Aug. 16, 2019

(30) Foreign Application Priority Data
Mar. 9, 2017 (JP) 2017-045079
Apr. 26, 2017 (JP) 2017-087057

(51) Int. Cl. C01B 32/162; C01B 32/176

(52) U.S. Cl. CPC C01B 32/162; C01B 2202/20; C01B 32/176

(57) ABSTRACT

Carbon nanotubes have at least one crystal defect in a region between a first end and a second end of the carbon nanotubes, of which a ratio (G/D) between an intensity IG of a peak caused by a graphite structure appearing in a G band around 1580 cm⁻¹ and an intensity of ID of a peak caused by various defects appearing in a D band around 1360⁻¹ in Raman spectrum obtained at an excitation wavelength of 632.8 nm is in a range of 0.1 to 0.5.

### TECHNICAL FIELD

The present invention relates to carbon nanotubes, a carbon-based fine structure, and a substrate having carbon nanotubes, and methods for producing the same.

Priority is claimed on Japanese Patent Application No. 2017-045079, filed Mar. 9, 2017 and Japanese patent application No. 2017-087057, filed Apr. 26, 2017, the content of which is incorporated herein by reference.

### BACKGROUND ART

Carbon nanotubes (hereinafter sometimes abbreviated as “CNT”) are material having a tube shape in which graphene sheets made of carbon atoms are wound in a cylindrical shape. In general, the diameter of the CNT is 100 nm or less. Since the CNT has excellent electrical and mechanical properties and low specific gravity, various applications have been expected.

Examples of the application of the CNT include a conductive auxiliary agent in a positive electrode and a negative electrode of a lithium ion secondary battery, a sheet material for an electric double layer capacitor, an electrocatalyst material of a fuel cell, and additives for imparting electro conductivity and thermal conductivity to a resin and ceramics.

Patent Document 1 discloses a carbon-based fine structure having a rope shape which is produced by forming a matrix (forest) of the carbon nanotubes on a flat substrate, drawing a carbon nanotube bundle (bundle) from the matrix by a drawing tool, and assembling the carbon nanotube bundles.

Further, Patent Document 2 discloses a carbon-based fine structure having a sheet shape which is produced by aligning a plurality of carbon nanotube bundles (bundles) which are oriented on a substrate (that is, the carbon nanotube bundles are formed so that the axial directions thereof extend in the same direction) in a direction perpendicular to the orientation direction to aggregate.

As the method for synthesizing the CNT, (1) a method for arc discharging between carbon electrodes, (2) a method for laser evaporating carbon, and (3) a method for thermal decomposing hydrocarbon gas have been known. However, from the viewpoint of synthesizing industrially a large amount of the CNT having constant quality, it is common to select (3) the method for thermal decomposing hydrocarbon gas.

In the method for synthesizing the CNT by the method for thermal decomposing hydrocarbon gas, the CNT is grown starting from catalyst particles provided on a substrate. Since metal particles such as iron particles are used as the catalyst particles, the produced CNT contains metal particles (metal impurities) as impurities.

However, since there are cases in which metal impurities may be disliked in the application of the CNT, a method for removing the metal impurities contained in the CNT to increase the purity of the CNT has been studied.

Further, in the carbon-based fine structures described in Patent Documents 1 and 2 described above, the catalyst component applied to the substrate is contained as an impurity when pulling out the carbon nanotube bundle from the substrate. Therefore, many impurities are contained in the carbon-based fine structures having a rope shape or a sheet shape. In this way, when carbon-based fine structure containing a large amount of impurities is used as a raw material for carbon-based fibers, laminated sheets, or the like, it causes performance degradation.

As a method for removing metal impurities contained in the CNT, methods disclosed in Patent Documents 3 and 4 have been known. Patent Document 3 discloses a method for evaporating and removing metal particles contained in the CNT at a high temperature of 1500° C. Further, Patent Document 4 discloses a method for dissolving and removing metal impurities contained in the CNT in an acid solution.

### PRIOR ART DOCUMENTS

### Patent Literature

Patent Document 1: Japanese Patent No. 3868914

Patent Document 2: Japanese Patent No. 4512750

Patent Document 3: Japanese Unexamined Patent Application, First Publication No. 2012-082105

Patent Document 4: Japanese Unexamined Patent Application, First Publication No. 2013-075784

### SUMMARY OF INVENTION

### Problem to be Solved by the Invention

However, the method described in Patent Document 3 requires equipment capable of heat treatment at a high temperature of 1500° C., and requires a great deal of heat energy.

The method described in Patent Document 4 requires equipment for the acid treatment, and additional steps such as pretreatment before immersion in an acid solution, cleaning and drying after the acid treatment in addition to the acid treatment of the CNT. In addition, during the additional steps related to the acid treatment, there is a risk that the CNT may be damaged, or the CNT may be degraded.

The present invention has been made in view of the above circumstances, and the present invention provides carbon nanotubes having a low amount of impurities, a carbon-based fine structure, a substrate having carbon nanotubes suitable for making the carbon nanotubes and the carbon-based fine structure, and methods for producing them.

### Means for Solving the Problem

The present invention provides the followings.
[1] Carbon nanotubes of which axial directions extend in one direction,

wherein each of the carbon nanotubes has at least one crystal defect in a region between a first end and a second end of the carbon nanotubes, and

the crystal defect has a ratio (G/D) between an intensity IG of a peak caused by a graphite structure appearing in a G band around 1580 cm⁻¹ and an intensity of ID of a peak caused by various defects appearing in a D band around 1360⁻¹ in Raman spectrum obtained at an excitation wavelength of 632.8 nm in a range of 0.1 to 0.5.
[2] The carbon nanotubes according to [1],

wherein the carbon nanotubes have the crystal defect in a portion within 50 μm from the first end or the second end in an axial direction.
[3] The carbon nanotubes according to [1],

wherein the carbon nanotubes have the crystal defect at the first end or the second end in the axial direction.
[4] The carbon nanotubes according to any one of [1] to [3],

wherein the carbon nanotubes have an axial length of 50 μm or more and 1000 μm or less.
[5] A carbon-based fine structure,

wherein the carbon-based fine structure is an aggregate including one or more carbon nanotube bundles which contains one or more carbon nanotubes according to [1], and

one or more carbon nanotubes extend in the same axial direction, and are aggregated.
[6] The carbon-based fine structure according to [5],

wherein the aggregate has a rope shape or a sheet shape.
[7] A substrate having carbon nanotubes,

wherein the substrate having carbon nanotubes includes a substrate, one or more catalyst particles provided on a surface of the substrate, and a plurality of the carbon nanotubes according to [1],

axial directions of a plurality of the carbon nanotubes extend in the same direction with respect to the surface of the substrate, and

each of a plurality of the carbon nanotubes has at least one crystal defect at the same height from the surface of the substrate.
[8] A method for producing the carbon nanotubes according to [1],

wherein the method includes:

a first step in which a gas containing a raw material gas is supplied to a substrate having a surface provided with one or more catalyst particles, and a plurality of carbon nanotubes extending in the same direction are grown on the surface of the substrate starting from the catalyst particles by using a chemical vapor deposition method; and

a second step in which crystal defects are introduced in the carbon nanotubes by reducing an amount of a gas supplied than an amount of the gas supplied in the first step.
[9] The method for producing the carbon nanotubes according to [8],

wherein the method includes twice or more of the first step.
[10] The method for producing the carbon nanotubes according to [8] or [9],

wherein the method includes twice or more of the second step.
[11] The method for producing the carbon nanotubes according to any one of [8] to [10],

wherein the method further includes a third step in which the carbon nanotubes are cut at a portion of the crystal defects introduced and the carbon nanotubes and the substrate are separated.
[12] A method for producing the aggregate according to [5],

wherein the method includes:

a first step in which a gas containing a raw material gas is supplied to a substrate having a surface provided with one or more catalyst particles, and a plurality of carbon nanotubes extending in the same direction are grown on the surface of the substrate starting from the catalyst particles by using a chemical vapor deposition method:

a second step in which crystal detects are introduced in the carbon nanotubes by reducing an amount of a gas supplied than an amount of the gas supplied in the first step; and

a third step in which a plurality of the carbon nanotubes are separated from the substrate while a plurality of the carbon nanotubes are cut at a portion in which the crystal defects are introduced, and a plurality of the carbon nanotubes are aggregated to form a carbon nanotube bundle, and an aggregate having a roper shape or a sheet shape is formed using one or more carbon nanotube bundle.
[13] A method for producing the substrate having carbon nanotubes according to [7], wherein the method includes:

a first step in which a gas containing a raw material gas is supplied to a substrate having a surface provided with one or more catalyst particles, and a plurality of carbon nanotubes extending in the same direction are grown on the surface of the substrate starting from the catalyst particles by using a chemical vapor deposition method; and

a second step in which crystal defects are introduced in the carbon nanotubes by reducing an amount of a gas supplied than an amount of the gas supplied in the first step.

### Effects of the Invention

The carbon nanotubes and the carbon-based fine structure of the present invention have a low amount of impurities.

The substrate having carbon nanotubes of the present invention is suitable for producing the carbon nanotubes and the carbon-based fine structure.

The method for producing the carbon nanotubes, the carbon-based fine structure and the substrate having carbon nanotubes of the present invention can easily produce the carbon nanotubes, the carbon-based fine structure and the substrate having carbon nanotubes.

### BRIEF DESCRIPTION OF DRAWINGS

FIG. 1 is a cross-sectional view schematically showing one embodiment of a substrate having carbon nanotubes according to the present invention.

FIG. 2 is a view showing one embodiment of a method for producing a substrate having carbon nanotubes according to the present invention.

FIG. 3 is a cross-sectional view schematically showing a method for taking out a carbon-based fine structure having a rope shape from a substrate having carbon nanotubes.

FIG. 4 is a perspective view schematically showing a method for taking out a carbon-based fine structure having a sheet shape from a substrate having carbon nanotubes.

### DETAILED DESCRIPTION OF THE PREFERRED EMBODIMENTS

Hereinafter, carbon nanotubes, a carbon-based fine structure and a substrate having carbon nanotubes, which are one embodiment according to the present invention will be described in detail with reference to the drawings, together with methods for producing them. Note that in the drawings used in the following description, in order to make features easy to understand, the features may be shown enlarged for the sake of convenience, and the dimensional ratio of each component is not always the same as the actual one.

<Substrate Having Carbon Nanotubes>

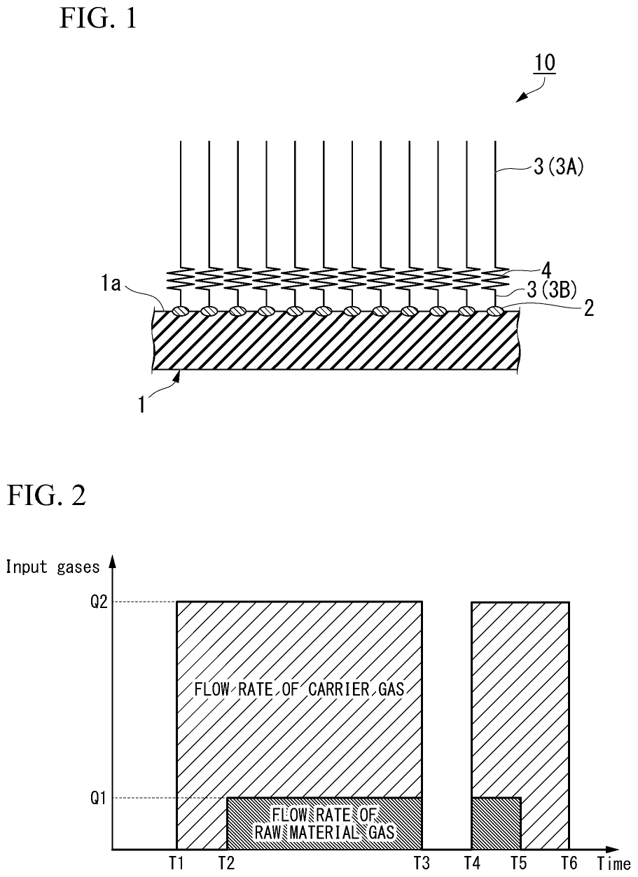

First, a substrate having carbon nanotubes, which is one embodiment according to the present invention, will be described. FIG. 1 is a cross-sectional view schematically showing an example of a substrate having carbon nanotubes according to the present invention.

As shown in FIG. 1, a substrate 10 having carbon nanotubes of the present embodiment has a substrate 1, one or more catalyst particles 2 provided on a surface 1a of the base 1, and a plurality of carbon nanotubes 3 which stand up from the catalyst particles 2 as base ends. The axial directions of a plurality of the carbon nanotubes 3 extend in the same direction with respect to the surface 1a of the substrate 1 (in FIG. 1, in the direction perpendicular to the surface 1a of the substrate 1). In other words, a plurality of the carbon nanotubes 3 are vertically oriented with respect to the surface 1a of the substrate 1. Further, one crystal defect 4 is provided in each of a plurality of the carbon nanotubes 3 so as to have the same height from the surface 1a of the substrate 1.

The substrate 1 is not particularly limited. The substrate 1 is preferably a substrate capable of supporting a plurality of the catalyst particles 2 (or a catalyst layer including a plurality of the catalyst particles 2). In addition, as described later, the substrate 1 is preferably a substrate having a smoothness which does not prevent the movement of the catalyst particles when the crystal particles are fluidized to arrange the catalyst particles 2 (or the catalyst layer) on the surface 1a of the substrate 1. Furthermore, the material of the substrate 1 is not particularly limited. However, the material of the substrate 1 is preferably a material having low reactivity with the catalyst particles 2 (particularly, metal particles). Examples of the substrate 1 include a single crystal silicon substrate. The single crystal silicon substrate is an excellent in terms of smoothness, cost and heat resistance.

When the single crystal silicon substrate is used as the substrate 1, it is preferable that the surface of the single crystal silicon substrate be oxidized or nitride in order to prevent a compound from being formed on the surface of the substrate. Thereby, a silicon oxide film (SiO₂ film) or a silicon nitride film (Si₃N₄ film) is formed on the surface of the single crystal silicon substrate. In addition, a film made of a metal oxide having low reactivity such as alumina may be formed on the surface of the single crystal silicon substrate.

The catalyst particles 2 are not particularly limited. As the catalyst particles 2, for example, metal particles such as nickel particles, cobalt particles, and iron particles can be used. Further, as the catalyst particles 2, it is preferable to use a single catalyst (metal catalyst) made of one kind of metal, and it is more preferable to use a single catalyst of iron. This makes it possible to form carbon nanotubes having a high purity.

The diameter of the catalyst particles 2 is not particularly limited. However, the diameter of the catalyst particles 2 is preferably 0.5 to 50 nm, and more preferably 0.5 to 15 nm.

In the substrate 10 having carbon nanotubes of the present embodiment, a catalyst layer including a plurality of the catalyst particles 2 may be provided on the surface 1a of the substrate 1. The thickness of the catalyst layer is not particularly limited. However, the thickness of the catalyst layer is preferably in a range of 0.5 to 100 nm, and more preferably in a range of 0.5 to 15 nm. When the thickness of the catalyst layer is 0.5 nm or more, the catalyst layer with a uniform thickness can be formed on the surface 1a of the substrate 1. When the thickness of the catalyst layer is 15 nm or less, the catalyst layer can be formed on the surface 1a of the substrate by heating the catalyst particles 2 at a temperature of 800° C. or less.

As shown in FIG. 1, the carbon nanotubes 3 constituting the substrate 10 having carbon nanotubes of the present embodiment are provided upright on the surface 1a of the substrate 1 from the catalyst particle 2 as the base end. In addition, the axial direction of all carbon nanotubes 3 is perpendicular to the surface 1a of the substrate 1. In other words, all carbon nanotubes 3 are vertically oriented with respect to the surface 1a of the substrate 1.

The axial length of the carbon nanotubes 3 is not particularly limited. The average axial length of the carbon nanotubes 3 is preferably 50 to 5000 μm, and more preferably 50 to 1000 μm from the viewpoint of productivity. When the average axial length of the carbon nanotubes 3 is in the range, the characteristics of the carbon nanotubes 3 can be sufficiently exhibited in various applications. Accordingly the average length in the axial direction of the carbon nanotubes 3 is preferably in the range.

The diameter of the carbon nanotubes 3 largely depends on the number of layers of carbon nanotubes, and is not particularly limited. The average diameter of the carbon nanotubes 3 is preferably 1 to 80 nm, and more preferably 4 to 20 nm. In particular, an effect of making carbon nanotubes 3 difficult to break can be obtained by setting the average diameter of carbon nanotubes 3 to 4 nm or more.

The crystallinity of the carbon nanotubes 3 is preferably better. In the carbon nanotubes 3, “G/D”, which is an index of the crystallinity of carbon nanotubes, is preferably 0.8 or more, and more preferably 12 or more. The carbon nanotubes having 12 or more of the “G/D” have less five-membered rings and seven-membered rings which are defective in the structure, so that breakage and the like can be reduced.

The “G/D” is a ratio between an intensity IG of a peak caused by a graphite structure appearing in a G band around 1580 cm⁻¹ and an intensity of ID of a peak caused by various defects appearing in the D band around 1360 cm⁻¹ in the Raman spectrum at obtained at the excitation wavelength of 632.8 nm.

The “G/D” can be calculated using a commercially available Raman spectrometer. In the carbon nanotubes, the splitting of the G band peak may be observed. In this case, a higher peak height may be adopted as the intensity IG of the peak.

Each of the carbon nanotubes 3 constituting the substrate 10 having carbon nanotubes of the present embodiment has one or more crystal defects 4 in which a portion is strongly bent arbitrarily. In other words, each of the carbon nanotubes 3, which have the catalyst particle 2 as the base end and the axial direction extending in the direction perpendicular to the surface 1a of the substrate 1, has one or more crystal defects 4 between the base end (first end) and the tip end (a second end). That is, a part 3B (portion 3B) from the catalyst particle 2 to the crystal defect 4, the crystal defect 4, and a part (portion 3A) beyond (tip side) the crystal defect 4 are bonded in this order in the carbon nanotube 3.

The crystal defect 4 is provided at an arbitrary portion between first end and the second end in the axial direction of each of the carbon nanotubes 3 over the entire direction (that is, the circumferential direction) orthogonal to the axial direction. The “G/D” of the crystal defect 4 is in a range of 0.1 to 0.5.

As described later, the crystal defects 4 are generated by making the crystal growth unstable and causing the irregular growth by blocking or reducing the concentration of the raw material gas at the time of formation of the carbon nanotubes 3 using the CVD reaction. Therefore, the crystal defects 4 are introduced into all carbon nanotubes 3 at the same height from the surface 1a of the substrate 1. In other words, the length of the 3B portions from the catalyst particles 2 to the crystal defects 4 is equal in all carbon nanotubes 3. Similarly, the length of the portions 3A ahead (tip side) from the crystal defect 4 is equal in all carbon nanotubes 3.

The position of the crystal defect 4 introduced into the carbon nanotubes 3 is not particularly limited. However, the crystal defects 4 are preferably provided at a position away from the catalyst particles 2 serving as the base end of the carbon nanotubes 3 (that is, a position higher than 0 μm from the surface 1a of the substrate 1). In other words, it is preferable to provide the 3B portion of the carbon nanotubes 3 between the catalyst particle 2 and the crystal defect 4. By providing the 3B portion between the catalyst particle 2 and the crystal defect 4, when separating the carbon nanotubes 3 (portion 3A) from the substrate 1, it is possible to separate the position (that is, the position to which stress is applied) of the crystal defect 4 serving as the starting point of the cut portion of the carbon nanotubes 3 from the bonding portion between the surface 1a of the substrate 1 and the catalyst particle 2. Therefore, when separating the carbon nanotubes 3 (portion 3A) from the substrate 1, it is possible to suppress that the catalyst particles 2 peel off from the surface 1a of the substrate 1 and become impurities of the carbon nanotubes 3.

On the other hand, the crystal defects 4 are preferably provided at a height within 50 μm from the surface 1a of the substrate 1. That is, the carbon nanotubes 3 preferably have the crystal defect 4 within 50 μm from the proximal end (first end) in the axial direction. In other words, the length of the 3B portion of the carbon nanotubes 3 is preferably 50 μm or less. Since when separating the carbon nanotubes 3 (portion 3A) from the substrate 1, the portion 3B is left on the substrate 1, the length of the portion 3B is preferably within 50 μm from the economical viewpoint.

In carbon nanotubes 3 having the crystal defects 4 in a part in the axial direction, the portion of crystal defects 4 is easily broken. For this reason, in the substrate having carbon nanotubes 10 of the present embodiment, when separating the carbon nanotubes 3 from the substrate 1, it is possible to easily cut in any parts of the bonding portion between portions 3A and the crystal defect 4, the crystal defect 4, and the bonding portion between the crystal defect 4 and the 3B portion by grasping portions 3A of the carbon nanotubes 3 and applying a stress in either direction. That is, portions 3A of the carbon nanotubes 3 can be reliably separated from the substrate 1 without peeling the catalyst particles 2 from the surface 1a of the substrate 1. In other words, the amount of the catalyst particles 2 as impurities can be reduced in portions 3A of the carbon nanotubes 3 separated from the substrate 1. Therefore, the substrate 10 having carbon nanotubes of the present embodiment is useful as a source of the carbon nanotubes and the carbon-based fine structures having a low amount of impurities (that is, high purity).

<Method for Producing Substrate Having Carbon Nanotubes>

Next, an example of a method for producing the substrate having the carbon nanotubes 3 will be described.

The method for producing the substrate 10 having carbon nanotubes 3 includes a first step in which a gas containing a raw material gas is supplied to the substrate 1 having the surface 1a provided with one or more catalyst particles 2, and a plurality of carbon nanotubes extending in the same direction are grown on the surface 1a of the substrate starting from the catalyst particles 2 by using a chemical vapor deposition method, and a second step in which the crystal defects 4 are introduced in the carbon nanotubes 3 by reducing the amount of a gas supplied than an amount of the gas supplied in the first step.

(Preparation Step)

In a preparation step, first, a catalyst layer including the catalyst particles 2 for growing the carbon nanotubes 3 is formed on the surface 1a of the substrate 1.

The method for forming the catalyst layer is not particularly limited. As the method for forming the catalyst layer, for example, it is possible to use a method for depositing metal on the surface 1a of the substrate 1 by a sputtering method, a vacuum evaporation method or the like; or a method for coating a catalyst solution on the surface 1a of the substrate 1 to form a coating layer, heating, and drying.

As the catalyst solution, for example, a catalyst solution containing one of metals such as nickel, cobalt and iron, or one of compounds of metal complexes such as nickel complex, cobalt complex and iron complex can be used.

Moreover, the method for coating the catalyst solution on the surface 1a of the substrate 1 is not specifically limited. Examples of the coating method include a spin coating method, a spray coating method, a bar coater method, an ink jet method, and a slit coater method.

The heating of the coating layer is preferably carried out in air atmosphere at atmospheric pressure, or under reduced pressure, or in a non-oxidizing atmosphere in a temperature in a range of 500° C. to 1000° C., and more preferably in a temperature in a range of 650° C. to 800° C. Thereby, the catalyst layer including a plurality of the catalyst particles 2 can be formed on the surface 1a of the substrate 1.

(First Step)

Next, in the first step, a chemical vapor deposition (CVD) method is used, and a mixed gas (gas) containing a raw material gas and a carrier gas is supplied to the surface 1a of the substrate 1 having the catalyst layer in a high temperature atmosphere to grow the carbon nanotubes using the catalyst particle 2 as nuclei. At this time, a plurality of the carbon nanotubes 3 are formed such that the axial directions are perpendicular to the surface 1a of the substrate 1 (vertical alignment). The temperature (formation temperature) when forming the carbon nanotubes 3 is not particularly limited. However, the formation temperature of the carbon nanotubes 3 is preferably in a range of 500° C. to 1000° C., and more preferably in a range of 650° C. to 800° C.

The length of one carbon nanotube 3 can be controlled by adjusting the amount of the raw material gas supplied, the synthesis pressure, and the reaction time in a chamber of the CVD apparatus. By lengthening the reaction time in the chamber of the CVD apparatus, the length of the carbon nanotubes 3 can be extended to about several mm.

As the raw material gas used for synthesis and growth of the carbon nanotubes 3, for example, gas of aliphatic hydrocarbon such as acetylene, methane and ethylene can be used. Among these, acetylene gas is preferable, and ultrahigh purity acetylene gas having an acetylene concentration of 99.9999% or more is more preferable.

When acetylene gas is used as the raw material gas, a plurality of the carbon nanotubes 3 having a diameter in a range of 0.5 to 50 nm are oriented and grown in a multilayer structure in a direction perpendicular to the surface 1a of the substrate 1 from the catalyst particles 2 serving as nuclei (origins of growth). In addition, the carbon nanotubes 3 having a high quality can be synthesized and grown by using ultra-high purity acetylene gas as the raw material gas.

Examples of the carrier gas for transporting the raw material gas include He, Ne, Ar, N₂ and H₂. Among these, He, N₂ and Ar are preferable, and He is more preferable.

The amount of the raw material gas in the total amount of the mixed gas containing the raw material gas and the carrier gas is preferably 5 to 100% by volume, and more preferably 10 to 100% by volume. When the amount of the raw material gas in the mixed gas is equal to or more than the lower limit value of the preferable range, the CNT can be densely synthesized on the surface 1a of the substrate 1. Therefore, as described later, when the substrate 10 having carbon nanotubes of the present embodiment is used as the source of the carbon-based fine structure, the carbon nanotubes in a rope shape or a sheet shape can be easily taken out from the surface 1a of the substrate 1.

(Second Step)

After the carbon nanotubes 3 (portion 3A) are sufficiently grown in the first step described above, the second step proceeds. In the second step, the amount of the gas supplied to the surface 1a of the substrate 1 is reduced compared to the amount of the gas supplied in the first step to introduce the crystal defect 4 into the carbon nanotubes 3.

In the method for producing the substrate 10 having carbon nanotubes of the present embodiment, “reducing the amount of a gas supplied” refers to the following cases (1) and (2).

(1) The amount of the mixed gas supplied in the second step is set to 0% or more and 10% or less of the amount of the mixed gas supplied in the first step. That is, while maintaining the ratio of the raw material gas to the carrier gas in the first step, the entire amount of the mixed gas supplied is reduced to 10% or less of the entire amount of the mixed gas supplied in the first step (in the case of 0%, shut off).

(2) The amount of the raw material gas in the mixed gas is set to 0% or more and 10% or less of the amount of the raw material gas in the mixed gas in the first step. In other words, while maintaining the amount of the carrier gas supplied in the first step, the amount of the raw material gas is reduced to 10% or less (including 0%) of the amount of the raw material gas in the first step.

The duration for reducing the amount of the gas supplied may be provided continuously or may be provided intermittently.

In the method for producing the substrate 10 having carbon nanotubes of the present embodiment, the crystal defect 4 can be introduced into the carbon nanotubes 3 (portions 3A) grown in the first step by having the duration for reducing the amount of the gas supplied (that is, the second step), as explained above.

In the method for producing the substrate 10 having carbon nanotubes of the present embodiment, the first step may be performed again after the second step. That is, the method for producing the substrate 10 having carbon nanotubes of the present embodiment may include two or more of the first steps. By returning the amount of the gas supplied to the amount of the gas supplied in the first step, the carbon nanotubes 3 (the portion 3B) without the crystal defect can be grown again so as to be continuous with the crystal defect 4 introduced to the end of the carbon nanotubes 3 (portions 3A). Thereby, the crystal defects 4 can be introduced into the carbon nanotubes 3 so as to have a predetermined height from the surface 1a of the substrate 1. In other words, the crystal defects 4 can be provided in a portion (position) away from the surface 1a of the substrate 1 in the axial direction of the carbon nanotubes 3.

Below, the first step and the second step in the method for producing the substrate 10 having carbon nanotubes of the present embodiment will be described in more detail with reference to FIGS. 1 and 2. FIG. 2 is a view showing the method for producing the substrate 10 having carbon nanotubes of the present embodiment, and is a view showing the time course of the gas flow rate in the CVD method.

As shown in FIG. 1, the substrate 1 having the surface 1a with the catalyst particles 2 is prepared and placed in a CVD apparatus (not shown).

As shown in FIG. 2, the supply of the carrier gas into the CVD apparatus is started at time T1. At this time, the carrier gas has a predetermined flow rate Q2. The raw material gas is shut off.

Next, the supply of the raw material gas into the CVD apparatus is started at time T2. The flow rate of the raw material gas instantaneously becomes a predetermined flow rate Q1. Further, since the flow rate of the carrier gas is Q2−Q1, the total amount of the gas supplied into the CVD apparatus does not change from time T1 to time T2. This state is continued during time T2 to T3.

That is, duration between time T2 and T3, the first step is carried out. As shown in FIG. 1, the carbon nanotubes 3 (portions 3A) grow from the catalyst particle 2 as a starting point in the first step.

Next, as shown in FIG. 2, the flow rate of the carrier gas and the raw material gas are reduced (stopped) at time T3. Due to the reduce of the gas flow rate, the crystal defects 4 are generated in the carbon nanotubes 3 which are grown while being oriented perpendicularly to the surface (surface of the catalyst substrate) 1a of the substrate 1. This state is continued during time T3 to T4.

That is, duration between time T3 and T4, the second step is carried out. As shown in FIG. 1, the crystal defects 4 are introduced at the end of carbon nanotubes 3 (portions 3A) in this second step.

Next, as shown in FIG. 2, the amount of the gas supplied at time T4 is set to the same as that at time T2 to T3. This state continues during time T4 to T5.

That is, the first step is performed again at time T4. As shown in FIG. 1, in the first step, the carbon nanotubes 3 (portion 3B) without the crystal defects grow again so as to continue from the crystal defects 4 introduced.

Next, as shown in FIG. 2, the supply of the raw material gas is shut off at time T5. This state is continued during time T5 to T6 to complete the CVD reaction. As described above, the substrate 10 having carbon nanotubes as shown in FIG. 1 can be produced.

<Carbon Nanotubes>

Next, an embodiment of the carbon nanotubes according to the present invention will be described. The carbon nanotubes of the present embodiment includes the carbon nanotubes in a state of being bonded to the surface 1a of the substrate 1 constituting the substrate 10 having carbon nanotubes, and the carbon nanotubes in a state of being separated from the surface 1a of the substrate 1 constituting the substrate 10 having carbon nanotubes.

The carbon nanotubes in a state of being bonded to the surface 1a of the substrate 1 is the same as the carbon nanotubes 3 constituting the substrate 10 having carbon nanotubes. In other words, as shown in FIG. 1, each of the carbon nanotubes 3 has one crystal defect 4 between a first end (base end) and a second end (tip end) in extending axial direction, and the crystal defect 4 has the ratio (G/D) between the intensity IG of the peak caused by the graphite structure appearing in the G band around 1580 cm⁻¹ and the intensity of ID of the peak caused by various defects appearing in the D band around 1360⁻¹ in the Raman spectrum obtained at the excitation wavelength of 632.8 nm in a range of 0.1 to 0.5. The details of the carbon nanotubes 3 will not be described.

The carbon nanotubes in a state of being separated from the substrate 1 (that is, the substrate 10 having carbon nanotubes) are the same as the portions 3A constituting the carbon nanotubes 3 described above. Therefore, the detailed description of the portions 3A of the carbon nanotubes 3 is omitted. When used in various applications, it is preferable that the carbon nanotubes 3 (portions 3A) separated from the substrate 1 do not have the crystal defect 4 from the viewpoint of exhibiting the performance of the carbon nanotubes.

The carbon nanotubes 3 (portions 3A) separated from the substrate 1 may have the crystal defect 4 at either end in the axial direction. In the method for producing the carbon nanotubes described later, since when the carbon nanotubes 3 (portion 3A) are separated from the substrate 1 by cutting the carbon nanotubes 3 at a portion in which the crystal defect 4 is introduced, a part of the crystal defect 4 remains at the end of the carbon nanotubes 3 (portions 3A).

The length of the carbon nanotubes 3 (portions 3A) separated from the substrate 1 is not particularly limited. The length of the carbon nanotubes 3 (portions 3A) is preferably 50 μm or more and 1000 μm or less, and more preferably 50 μm or more and 600 μm or less, from the viewpoint of using the carbon nanotubes for various applications. When the length of the carbon nanotubes 3 (portions 3A) separated from the substrate 1 is in the preferable range, the performance of the carbon nanotubes can be sufficiently exhibited.

In the substrate 10 having carbon nanotubes, since the lengths of the portions 3A are the same in a plurality of the carbon nanotubes, the lengths of a plurality of the carbon nanotubes 3 (the portions 3A) separated from the substrate 1 are the same. Therefore, it is possible to provide the carbon nanotubes 3 (portions 3A) with less variation in quality.

<Method for Producing Carbon Nanotubes>

Next, the method for producing the carbon nanotubes will be described.

The method for producing the carbon nanotubes 3 in a state of being bonded to the substrate 1 is the same as the method for producing the substrate 10 having carbon nanotubes described above. Therefore, the detailed description of the method for producing carbon nanotubes 3 in a state of being bonded to the substrate 1 will be omitted.

The method for producing the carbon nanotubes 3 (portions 3A) separated from the substrate 1 includes a first step in which a gas containing a raw material gas is supplied to the substrate 1 having the surface 1a provided with one or more catalyst particles 2, and a plurality of carbon nanotubes 3 extending in the same direction are grown on the surface 1a of the substrate 1 starting from the catalyst particles 2 by using a chemical vapor deposition method; a second step in which the crystal defects 4 are introduced in the carbon nanotubes 3 by reducing the amount of a gas supplied than the amount of the gas supplied in the first step; and a third step in which the carbon nanotubes 3 are cut at a portion of the crystal defects 4 introduced and the carbon nanotubes 3 (portions 3A) and the substrate 1 are separated. That is, the method for producing the carbon nanotubes 3 (portions 3A) separated from the substrate 1 is obtained by newly adding the third step to the method for producing the substrate 10 having carbon nanotubes 3 described above. Therefore, a detailed description of the first and second steps is omitted.

(Third Step)

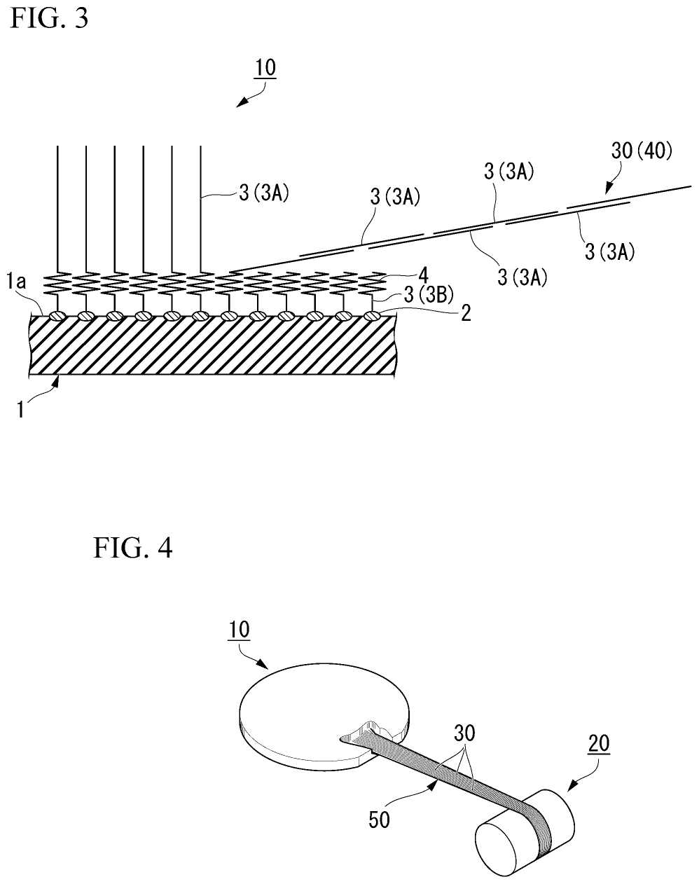

In the third step, the carbon nanotubes 3 (portions 3A) and the substrate 1 are separated by cutting the carbon nanotubes 3 at the portion in which the crystal defects 4 are introduced. The method for separating the carbon nanotubes 3 (portions 3A) and the substrate 1 is not particularly limited. As the method for separating the carbon nanotubes 3 (portion 3A) and the substrate 1, a method for peeling with a spatula such as a scraper, or a method for transfer with an adhesive tape can be used. The carbon nanotubes 3 in which the crystal defect 4 is introduced in the axial direction can be easily cut at the portion in which the crystal defect 4 is introduced. Therefore, only the carbon nanotubes 3 (portions 3A) can be separated from the substrate 1 while the catalyst particles 2 used when growing carbon nanotubes 3 remain on the surface 1a of the substrate 1 (see FIG. 3 described later). Therefore, according to the method for producing the carbon nanotubes 3 (portions 3A) separated from the substrate 1, the carbon nanotubes 3 (portions 3A) which contain a small amount of the catalyst particles as impurities, and have having a high purity can be produced.

<Carbon-Based Fine Structure>

Next, one embodiment of the carbon-based fine structure according to the present invention will be described. FIG. 3 is a cross-sectional view schematically showing the carbon-based fine structure having a rope shape and a method for taking out the carbon nanotubes as the carbon-based fine structure having a rope shape. FIG. 4 is a perspective view schematically showing the carbon-based fine structure having a sheet shape and a method for taking out the carbon nanotubes as the carbon-based fine structure having a sheet shape.

As shown in FIG. 3, the carbon-based fine structure of this embodiment is made from a carbon nanotube bundle 30 which includes one or more carbon nanotubes 3 (portions 3A) separated from the substrate 1 as described above, and in which one or more carbon nanotubes 3 (portions 3A) having the axial directions extending in the same direction are aggregated by van der Waals force. The carbon nanotube bundle 30 is a structure in which a plurality of the carbon nanotubes 3 (portions 3A) are aggregated while being slightly offset in the axial direction, and behave like a single fiber.

As shown in FIG. 3, the carbon-based fine structure 40 having a rope shape is an aggregate having a rope shape in which one or more carbon nanotube bundles 30 are further agglomerated in the axial direction by van der Waals force. In addition, as shown in FIG. 4, the carbon-based fine structure having a sheet shape (carbon nanotube sheet) 50 is an aggregate having a rope shape in which a plurality of the carbon nanotube bundles 30 are further aggregated in a state in which a plurality of the carbon nanotube bundles 30 are arranged in a direction (width direction of the sheet) orthogonal to the axial direction by van der Waals force.

<Method for Producing Carbon-Based Fine Structure>

Next, the method for producing the carbon-based fine structure described above will be described.

The method for producing the carbon-based fine structure 40, 50 of the present embodiment includes a first step in which the gas containing the raw material gas is supplied to the substrate having the surface 1a provided with one or more catalyst particles 2, and a plurality of the carbon nanotubes extending in the same direction are grown on the surface 1a of the substrate 1 starting from the catalyst particles 2 by using a chemical vapor deposition method; a second step in which the crystal defects 4 are introduced in the carbon nanotubes by reducing the amount of the gas supplied than the amount of the gas supplied in the first step; and a third step in which a plurality of the carbon nanotubes (portions 3A) are separated from the substrate 1 while a plurality of the carbon nanotubes 3 are cut at a portion in which the crystal defects 4 are introduced, and the plurality of the carbon nanotubes 3 (portions 3A) are aggregated by van der Waals force to form the carbon nanotube bundle 30, and the aggregate having roper shape or a sheet shape is formed using the one or more carbon nanotube bundle 30. That is, the method for producing the carbon-based fine structures 40 and 50 is obtained by adding the new third step, which is different from the third step in the method for producing the carbon nanotubes, in the method for producing the substrate 10 having carbon nanotubes described above. Therefore, a detailed description of the first and second steps is omitted.

(Third Step)

In the third step, the carbon nanotubes 3 (portions 3A) and substrate 1 are separated by cutting the carbon nanotubes 3 at the portion in which the crystal defects 4 are introduced. When separating the carbon nanotubes 3 (portions 3A) and the substrate 1, a part of the carbon nanotubes 3 (portions 3A) is drawn out to form the carbon nanotube bundle 30.

As shown in FIG. 3, when the carbon nanotubes 3 (portions 3A) are closely crowded to each other by van der Waals force, and a part of the carbon nanotubes 3 (portions 3A) formed on the surface 1a of the substrate 1 is pulled up with a tweezer, or the like, some of nearby carbon nanotubes 3 (portions 3A) follow the bundle of the carbon nanotubes 3 (portions 3A) pulled up. Thereby, it is possible to form the carbon nanotube bundle 30 in which bundles of the carbon nanotubes 3 (portions 3A) are continuous.

That is, the carbon nanotubes 3 (portions 3A) are separated from the substrate 1 while the crystal defects 4 which are introduced in the carbon nanotubes 3 are cut by losing van der Waals force in which the carbon nanotubes try to aggregate, and the carbon nanotubes 3 (portions 3A) cut are aggregated to form the carbon nanotube bundle 30. Therefore, the catalyst particles 2 remain on the substrate 1, and the carbon nanotubes 3 (portions 3A) separated from the substrate 1 can be taken out as the carbon nanotube bundle 30 containing no metal catalyst 2 at all. Then, one or more carbon nanotube bundles 30 may be further aggregated in a rope shape to form the carbon-based fine structure having a rope shape 40. By this method, it is possible to provide the carbon-based fine structure 40 having a rope shape (having a high purity) having a low amount of impurity without requiring a purification step and equipment.

As shown in FIG. 4, the carbon nanotube bundle 30 which has been pulled out becomes easy to pull out continuously, the aggregate including a plurality of the carbon nanotube bundles 30 becomes like a band, and the carbon nanotube bundles 30 having a sheet shape is separated from the substrate 10 having carbon nanotubes using a roller 20 or the like, and can be easily recovered. Thus, the carbon nanotubes 3 (portions 3A) recovered as the carbon-based fine structure 50 having a sheet shape can be used as an electrode material of a secondary battery, a sheet material for an electric double layer capacitor, an electrode catalyst material of a fuel cell, or a conductivity imparting additives for resin parts.

(Concentration of Impurities)

The carbon nanotubes 3 (portions 3A) constituting the carbon-based fine structure having a rope shape or a sheet shape according to the present embodiment have a smaller amount of the catalyst particles 2 which are impurities than the amount of the catalyst particles 2 in the carbon nanotubes constituting the carbon-based fine structure which is produced by the conventional producing method. Accordingly, the carbon-based fine structure having a rope shape or a sheet shape according to the present embodiment has higher purity. The carbon-based fine structure according to the present embodiment has preferably a carbon purity of 99.99% or more, and more preferably 99.999% or more.

The concentration of the catalyst particles 2 such as iron contained in the carbon nanotubes 3 and the carbon-based fine structures 40 and 50 can be measured by ICP mass spectrometry using a commercially available ICP mass spectrometer (manufactured by Thermo Electron, “X series II”, etc.)

As described above, the carbon nanotube 3 of the present embodiment has one or more crystal defects 4 of which the ratio (G/D) of the peak intensities in the Raman spectrum is in a range of 0.1 to 0.5 in the state in which the carbon nanotube 3 is provided on the substrate 1. Thereby, even when the catalyst particles 2 such as iron as impurities are present at the base end of carbon nanotubes 3, the carbon nanotubes 3 can be cut starting from crystal defect 4. Therefore, the catalyst particles 2 can be separated in the state of being left on the substrate 1 side. Therefore, since the amount of the catalyst particles 2 to be impurities can be reduced, the purity of the carbon nanotubes 3 can be easily increased.

The method for producing the carbon nanotubes 3 of the present embodiment includes the step of reducing the amount of the gas supplied to the surface 1a of the substrate 1 to introduce the crystal defects 4 into the carbon nanotubes 3. Therefore, the carbon nanotubes 3 (portions 3A) and the substrate 1 can be separated from the introduced crystal defect 4 as a starting point. At this time, since the catalyst particles 2 remain on the surface 1a of the substrate 1, the purity of the carbon nanotubes 3 can be easily increased.

The method for producing the carbon-based fine structure of the present embodiment includes the step of reducing the amount of the gas supplied to the surface 1a of the substrate 1 to introduce the crystal defects 4 in the carbon nanotubes 3 when producing the carbon nanotubes 3 constituting the carbon-based fine structure. Therefore, when the carbon nanotube bundle 30 is taken out from the base material 1, the carbon nanotubes 3 (portions 3A) and the substrate 1 can be easily separated from the crystal defect 4 introduced. At that time, since the catalyst particles 2 remain on the surface 1a of the substrate 1, the purity of the carbon-based fine structure can be easily increased.

In the substrate 10 having carbon nanotubes of the present embodiment, each of a plurality of the carbon nanotubes 3 has one crystal defect 4 having the same height from the surface 1a of substrate 1. As a result, the carbon nanotubes 3 can be cut starting from the crystal defect 4 to separate the carbon nanotubes 3 (portions 3A) from the substrate 1. At that time, since the catalyst particles 2 remain on the substrate 1, the purity of the carbon nanotubes 3 (portions 3A) can be easily increased. Therefore, the substrate 10 having carbon nanotubes of the present embodiment is suitable as a source of the carbon nanotubes and the carbon-based fine structures.

The technical scope of the present invention is not limited to the above embodiments, and various modifications can be made without departing from the scope of the present invention. In the method for producing the substrate 10 having carbon nanotubes, the carbon nanotubes, and the carbon-based fine structures in the embodiments, as shown in FIG. 1 and FIG. 2, an example in which after performing the first step and the second step, the first step is performed again. However, the present invention is not limited to this example. For example, after the first step and the second step are performed, the first step may not be performed again. Thereby, the growth of the portion 3B of the carbon nanotubes shown in FIG. 1 can be omitted.

In the embodiment described above, after performing the first step twice, the second step may be performed again to introduce a second crystal defect. That is, each of the first and second steps may be performed twice or more in the production method for the present invention.

Hereinafter, the effects of the present invention will be described in detail by Examples and Comparative Examples. The present invention is not limited to the contents of the following embodiments.

<Verification Test 1>

### EXAMPLE 1

The substrate having carbon nanotubes was synthesized under the conditions shown in FIG. 2. A catalyst solution containing iron nitrate was applied to a silicon wafer (base material) to form a catalyst layer containing a metal catalyst (catalyst particles) on the surface of the substrate. The substrate was put into a reaction chamber, and CNT synthesis was performed by the CVD method. The flow rate (Q1) of the raw material gas shown in FIG. 2 was 100 sccm. The flow rate (Q2−Q1) of the carrier gas was 900 sccm, and the total flow rate (Q2) was 1000 sccm. Further, in FIG. 2, the duration between T1 to T2 was 100 sec, the duration between T2 to T3 was 540 sec, the duration between T3 to T4 was 30 sec, the duration between T4 to T5 was 30 sec, and the duration between T5 to T6 was 100 sec. Furthermore, the flow rate of the raw material gas between T3 and T4 was 0 sccm, and the flow rate of the carrier gas also continued at 0 sccm. The temperature in the reaction chamber was 700° C., and the pressure was atmospheric pressure (1×10⁵ Pa).

By synthesizing the CNT under the conditions, the substrate having carbon nanotubes, which can produce the carbon-based fine structure having a rope shape, was produced.

In order to measure the G/D of the crystal defect part and a part without the crystal defect in the synthesized CNT area (array), Raman spectrum was measured with a microscopic Raman spectrometer. G/D was calculated based on the intensity ratio between the G-band peak (near 1590 cm⁻¹) and the D-band peak (near 1350 cm⁻¹). As a result, G/D=0.4 in the portion with the crystal defects, and G/D=1.1 in the portion without the crystal defects. It was confirmed that G/D was low in the portion with the crystal defects.

Next, the carbon nanotubes were separated from the substrate having carbon nanotubes and taken out to a roller as the carbon-based fine structure having a rope shape. The CNT produced as the carbon-based fine structure having a rope shape was used as the CNT sample in Example 1.

Next, 50 g of the obtained carbon-based fine structure having a rope shape was dissolved in a mixed acid of nitric acid, hydrofluoric acid and perchloric acid using a microwave decomposition apparatus. This decomposition solution was diluted 20 times, and the concentration of iron as the catalyst particles was measured by ICP mass spectrometry using an ICP mass spectrometer (manufactured by Thermo Electron, “X series II”) (Measurement mass number [m/z]: Fe: 56[Rh: 103 (CCT)]). The results are shown in Table 1.

### COMPARATIVE EXAMPLE 1

The same procedure as in Example 1 was carried out except that a duration between T3 to T4 was set to 0 sec not to make the crystal defects, and 50 mg of the carbon-based fine structure having a rope shape was dissolved, and the concentration of iron was measured. The results are shown in Table 1.

### REFERENCE EXAMPLE 1

After preparing the substrate having carbon nanotubes without making crystal defects as in Comparative Example 1, the CNTs were separated from the substrate with a scraper, and 50 mg of CNTs fired at 2500° C. for 1 hour in an Ar atmosphere were dissolved in the same manner. The iron concentration was measured in the same way. The results are shown in Table 1.

TABLE 1

| | Method for producing | Fe concentration |
|---|---|---|
| Example 1 | rope shape | detection limit (10 ppm) or less |
| | crystal defects: included | |
| Comparative | rope shape | 30 ppm |
| Example 1 | crystal defects: not | |
| | included | |
| Reference | scraper | detection limit (10 ppm) or less |
| Example 1 | thermal treatment: | |
| | 2500° C. | |

As shown in Table 1, the concentration of iron used as the catalyst particles was 30 ppm in Comparative Example 1. Therefore, it was confirmed that high purity CNTs could not be obtained by the method for Comparative Example 1.

In addition, the concentration of iron in Reference Example 1, in which the carbon nanotubes taken out as the carbon-based fine structure having a rope shape were heat-treated at 2500° C. under Ar atmosphere and the Fe particles were evaporated and removed, was 10 ppm or less (the detection limit or less).

On the other hand, the concentration of iron used as the catalyst particles was 10 ppm (lower limit of detection) or less in Example 1. Therefore, it was confirmed that in Example 1, high purity CNTs having a carbon purity of 99.999% or higher could be obtained by a simple method without heat treatment at a high temperature of 2500° C.

<Verification Test 2>

### EXAMPLE 2

In the same manner as in Example 1 described above, the substrate having carbon nanotubes was produced. Next, the carbon nanotubes were separated from the substrate having carbon nanotubes and taken out to a roller as the carbon-based fine structure having a sheet shape (carbon nanotube sheet). The CNT produced as the carbon-based fine structure having a rope shape was used as the CNT sample in Example 2.

Next, 50 g of the obtained carbon-based fine structure having a rope shape was dissolved in a mixed acid of nitric acid, hydrofluoric acid and perchloric acid using a microwave decomposition apparatus. This decomposition solution was diluted 20 times, and the concentration of iron as the catalyst particles was measured by ICP mass spectrometry using an ICP mass spectrometer (manufactured by Thermo Electron, “X series II”) (Measurement mass number [m/z]: Fe: 56 [Rh: 103 (CCT)]). The results are shown in Table 2.

### COMPARATIVE EXAMPLE 2

The same procedure as in Example 2 was carried out except that the duration between T3 to T4 was set to 0 sec not to make the crystal defects, and 50 mg of the carbon nanotube sheet was dissolved, and the concentration of iron was measured. The results are shown in Table 2.

TABLE 2

| | Method for producing | Fe concentration |
|---|---|---|
| Example 2 | sheet shape | detection limit (10 ppm) or |
| | crystal defects: included | less |
| | heat-treatment: not included | |
| Comparative | sheet shape | 30 ppm |
| Example 2 | crystal defects: not included | |
| | heat-treatment: not included | |

As shown in Table 2, the concentration of iron used as the catalyst particles was 10 ppm (lower limit of detection) or less in Example 2. Accordingly, it was confirmed that the carbon nanotube sheet with a high purity of 99.999% or higher could be obtained without high temperature treatment or acid treatment in Example 2.

On the other hand, the concentration of iron used as the catalyst particles was 30 ppm in Comparative Example 2. Accordingly, it was confirmed that the method for Comparative Example 2 could not produce a carbon nanotube sheet of high purity.

### INDUSTRIAL APPLICABILITY

Since the carbon nanotubes of the present invention has a low amount of impurities, the carbon nanotubes of the present invention can be used in the fields of electrode materials for secondary batteries, sheet materials for electric double layer capacitors, electrocatalyst materials for fuel cells, and conductivity imparting additives to resin parts.

### EXPLANATION OF REFERENCE NUMERAL

1 substrate
2 catalyst particle
3 carbon nanotube
4 crystal defect
10 substrate having carbon nanotubes
20 roller
30 carbon nanotube bundle
40 carbon-based fine structure having a rope shape
50 carbon-based fine structure having a sheet shape

1. Carbon nanotubes of which axial directions extend in one direction,
wherein each of the carbon nanotubes has at least one crystal defect in a region between a first end and a second end of the carbon nanotubes, and
the crystal defect has a ratio (G/D) between an intensity IG of a peak caused by a graphite structure appearing in a G band around 1580 cm⁻¹ and an intensity of ID of a peak caused by various defects appearing in a D band around 1360⁻¹ in Raman spectrum obtained at an excitation wavelength of 632.8 nm in a range of 0.1 to 0.5.

2. The carbon nanotubes according to claim 1,
wherein the carbon nanotubes have the crystal defect in a portion within 50 μm from the first end or the second end in an axial direction.

3. The carbon nanotubes according to claim 1,
wherein the carbon nanotubes have the crystal defect at the first end or the second end in the axial direction.

4. The carbon nanotubes according to claim 1,
wherein the carbon nanotubes have an axial length of 50 μm or more and 1000 μm or less.

5. A carbon-based fine structure,
wherein the carbon-based fine structure is an aggregate including one or more carbon nanotube bundles which comprise one or more carbon nanotubes according to claim 1, and
one or more carbon nanotubes extend in the same axial direction, and are aggregated.

6. The carbon-based fine structure according to claim 5,
wherein the aggregate has a rope shape or a sheet shape.

7. A substrate having carbon nanotubes,
wherein the substrate having carbon nanotubes comprises a substrate, one or more catalyst particles provided on a surface of the substrate, and a plurality of the carbon nanotubes according to claim 1,
axial directions of a plurality of the carbon nanotubes extend in the same direction with respect to the surface of the substrate, and
each of a plurality of the carbon nanotubes has at least one crystal defect at the same height from the surface of the substrate.

8. A method for producing the carbon nanotubes according to claim 1,
wherein the method comprises:
a first step in which a gas comprising a raw material gas is supplied to a substrate having a surface provided with one or more catalyst particles, and a plurality of carbon nanotubes extending in the same direction are grown on the surface of the substrate starting from the catalyst particles by using a chemical vapor deposition method; and
a second step in which crystal defects are introduced in the carbon nanotubes by reducing an amount of a gas supplied than an amount of the gas supplied in the first step.

9. The method for producing the carbon nanotubes according to claim 8,
wherein the method comprises twice or more of the first step.

10. The method for producing the carbon nanotubes according to claim 8,
wherein the method comprises twice or more of the second step

11. The method for producing the carbon nanotubes according to claim 8,
wherein the method further comprises a third step in which the carbon nanotubes are cut at a portion of the crystal defects introduced and the carbon nanotubes and the substrate are separated.

12. A method for producing the aggregate according to claim 5,
wherein the method comprises:
a first step in which a gas comprising a raw material gas is supplied to a substrate having a surface provided with one or more catalyst particles, and a plurality of carbon nanotubes extending in the same direction are grown on the surface of the substrate starting from the catalyst particles by using a chemical vapor deposition method;
a second step in which crystal defects are introduced in the carbon nanotubes by reducing an amount of a gas supplied than an amount of the gas supplied in the first step; and
a third step in which a plurality of the carbon nanotubes are separated from the substrate while a plurality of the carbon nanotubes are cut at a portion in which the crystal defects are introduced, and a plurality of the carbon nanotubes are aggregated to form a carbon nanotube bundle, and an aggregate having a roper shape or a sheet shape is formed using one or more carbon nanotube bundle.

13. A method for producing the substrate having carbon nanotubes according to claim 7.
wherein the method comprises:
a first step in which a gas comprising a raw material gas is supplied to a substrate having a surface provided with one or more catalyst particles, and a plurality of carbon nanotubes extending in the same direction are grown on the surface of the substrate starting from the catalyst particles by using a chemical vapor deposition method; and
a second step in which crystal defects are introduced in the carbon nanotubes by reducing an amount of a gas supplied than an amount of the gas supplied in the first step.
